(19) United States
(12) Patent Application Publication
(10) Pub. No.: US 2015/0366032 A1
(43) Pub. Date: Dec. 17, 2015

(54) RETAINING CIRCUIT AND LIGHT EMITTING DEVICE DRIVER CIRCUIT WITH RETAINING CIRCUIT

(71) Applicants: Tong-Cheng Jao, Taichung (TW); Issac Y. Chen, Zhubei City (TW); Yi-Wei Lee, Taipei (TW)

(72) Inventors: Tong-Cheng Jao, Taichung (TW); Issac Y. Chen, Zhubei City (TW); Yi-Wei Lee, Taipei (TW)

(73) Assignee: RICHTEK TECHNOLOGY CORPORATION, Zhubei City (TW)

(21) Appl. No.: 14/482,433

(22) Filed: Sep. 10, 2014

(30) Foreign Application Priority Data
Jun. 11, 2014 (TW) 103210240

(51) Int. Cl. H05B 37/02

(52) U.S. Cl. CPC H05B 37/02

(57) ABSTRACT

A retaining circuit includes: a low dropout regulator (LDO) circuit for generating a primary operation voltage, a secondary operation voltage generation (SOVG) circuit, and a memory circuit. The SOVG circuit generates a secondary operation voltage, and the memory circuit is powered by the secondary operation voltage to store at least one operation parameter, such that when the primary operation voltage is lower than a non-controlled level, the memory circuit holds the operation parameter to sustain operation.

### CROSS REFERENCE

The present invention claims priority to TW 103210240, filed on Jun. 11, 2014.

### BACKGROUND OF THE INVENTION

1. Field of Invention

The present invention relates to a retaining circuit and a light emitting device driver circuit with the retaining circuit; particularly, it relates to a retaining circuit capable of provide multiple operation voltages and a light emitting device driver circuit which includes such a retaining circuit.

2. Description of Related Art

FIG. 1 shows a schematic diagram of a prior art light emitting diode (LED) switch module 10 and its related circuit. As shown in FIG. 1, the LED switch module 10 includes a switch circuit 11 and a switch control circuit 12. The LED switch module 10 drives an LED circuit 20. The LED circuit 20 includes plural LEDs connected in series, and the plural LEDs are divided into plural LED groups, such as four LED groups G1, G2, G3, and G4 as shown in FIG. 1. The switch circuit 11 includes plural switches (such as four switches S1, S2, S3, and S4 as shown in FIG. 1) , which are electrically connected to the corresponding LED groups G1, G2, G3, and G4 respectively. A rectifier circuit 30 rectifies an AC voltage generated from an AC power source 40, to generate a rectified input voltage Vin. The circuit operates as thus. The LED switch module 10 drives the LED circuit 20 by turning ON or OFF the switches S1-S4 according to a level of the rectified input voltage Vin, and one or more LED group (s) G1-G4 glow (s) accordingly.

For example, as shown by the signal waveforms of FIG. 1, when the level of the rectified input voltage Vin is between levels L1 and L2, the switch control circuit 12 turns ON the switch S1 and turns OFF the switches S2-S4, so the LED group G1 glows. Similarly, when the level of the rectified input voltage Vin is between levels L2 and L3, the switch control circuit 12 turns ON the switch S2 and turns OFF the switches S1 and S3-S4, so the LED groups G1-G2 glow. Similarly, when the level of the rectified input voltage Vin is between levels L3 and L4, the switch control circuit 12 turns ON the switch S3 and turns OFF the switches S1-S2 and S4, so the LED groups G1-G3 glow. Similarly, when the level of the rectified input voltage Vin exceeds level L4, the switch control circuit 12 turns ON the switch S4 and turns OFF the switches S1-S3, so the LED groups G1-G4 glow. For reference, U.S. Pat. No. 7,081,722 and US 2011/0273102 disclose relevant circuits.

An advantage of this prior art LED switch module 10 over a driver circuit which drives the LED circuit by a DC voltage is that the manufacturing cost of the LED switch module 10 is relatively lower because it does not need to convert the rectified input voltage to the DC voltage. If the rectified input voltage has a frequency which is high enough, a naked eye will not perceive flickering of the LED circuit 20. However, the prior art LED switch module 10 has the following drawback. Because the operation voltage (not shown) of the switch control circuit 12 is also supplied by the rectified input voltage Vin which is generated by the rectifier circuit 30, when the level of the rectified input voltage Vin is close to zero, the operation voltage of the switch control circuit 12 also decreases to near zero, which is not sufficient for supporting internal basic operations of the switch control circuit 12 (such as providing power to a storage unit for storing the lightness setting, etc.). Thus, during the power-off period, the internal circuitry of the switch control circuit 12 is not under well control and parameters such as a lightness setting, etc. are lost, which may even cause serious out-of-control of the system.

In view of above, the present invention proposes a retaining circuit and a light emitting device driver circuit capable of providing multiple operation voltages to overcome the drawback in the prior art.

### SUMMARY OF THE INVENTION

From one perspective, the present invention provides a retaining circuit, including: a low dropout regulator (LDO) circuit, for converting a rectified input voltage to a primary operation voltage; a secondary operation voltage generation circuit, which is coupled to the LDO circuit, for generating a secondary operation voltage according to the primary operation voltage; and a memory circuit, which is coupled to the secondary operation voltage generation circuit, and powered by the secondary operation voltage to store at least one operation parameter; wherein the primary operation voltage is supplied to an operation circuit in a normal operation mode whereby the operation circuit operates according to the operation parameter, and when the primary operation voltage is lower than a non-controlled level whereby the operation circuit is in a non-controlled mode, the memory circuit holds the operation parameter such that the operation circuit retrieves the operation parameter from the memory circuit to sustain operation.

In one preferable embodiment, the LDO circuit further includes a first check device, for preventing a current flowing from the operation circuit or the SOVG circuit to the LDO circuit.

In one preferable embodiment, the retaining circuit further includes a second check device, which is coupled to the secondary voltage generation circuit, for preventing a current flowing from the secondary operation voltage generation circuit to the LDO circuit and the operation circuit.

In one preferable embodiment, the retaining circuit further includes a level shift circuit, which is coupled to the memory circuit and the operation circuit, for transmitting the operation parameter between the memory circuit and the operation circuit.

From another perspective, the present invention provides a light emitting device driver circuit for driving a light emitting device circuit, the light emitting device circuit including a plurality of light emitting devices connected in series for receiving a rectified input voltage. The light emitting driver circuit includes: a switch module, which includes a plurality of switches and a switch control circuit, wherein the plural switches are respectively coupled to at least one of the light emitting devices correspondingly, and the switch control circuit determines which one or ones of the light emitting devices are driven according to the rectified input voltage; and a retaining circuit, which is coupled to the switch control circuit, the retaining circuit including: a low dropout regulator (LDO) circuit, for converting the rectified input voltage to a primary operation voltage; a secondary operation voltage generation circuit, which is coupled to the LDO circuit, for generating a secondary operation voltage according to the primary operation voltage; and a memory circuit, which is coupled to the secondary operation voltage generation circuit, and powered by the secondary operation voltage to store at least one operation parameter; wherein the primary operation voltage is supplied to the switch module, in a normal operation mode whereby the switch module operates according to the operation parameter, and when the primary operation voltage is lower than a non-controlled level whereby the switch module is in a non-controlled mode, the memory circuit holds the operation parameter such that the switch module retrieves the operation parameter from the memory circuit to sustain operation.

In one preferable embodiment, the LDO circuit further includes a first check device, for preventing a current flowing from the operation circuit or the secondary operation voltage generation circuit to the LDO circuit.

In one preferable embodiment, the retaining circuit further includes a second check device, which is coupled to the secondary voltage generation circuit, for preventing a current flowing from the secondary operation voltage generation circuit to the LDO circuit and the operation circuit.

In one preferable embodiment, the retaining circuit further includes a level shift circuit, which is coupled to the memory circuit and the operation circuit, for transmitting the operation parameter between the memory circuit and the operation circuit.

The objectives, technical details, features, and effects of the present invention will be better understood with regard to the detailed description of the embodiments below.

### BRIEF DESCRIPTION OF THE DRAWINGS

FIG. 1 shows a schematic diagram of a prior art light emitting diode (LED) switch module 10 and its relate circuit.

FIG. 2 shows a first embodiment of the present invention.

FIG. 3 shows a second embodiment of the present invention.

FIG. 4 shows a third embodiment of the present invention.

FIG. 5 shows a schematic diagram of signal waveforms of the rectified input voltage Vin, a primary operation voltage Vp, a secondary operation voltage Vs, and a non-control level Vn of the present invention.

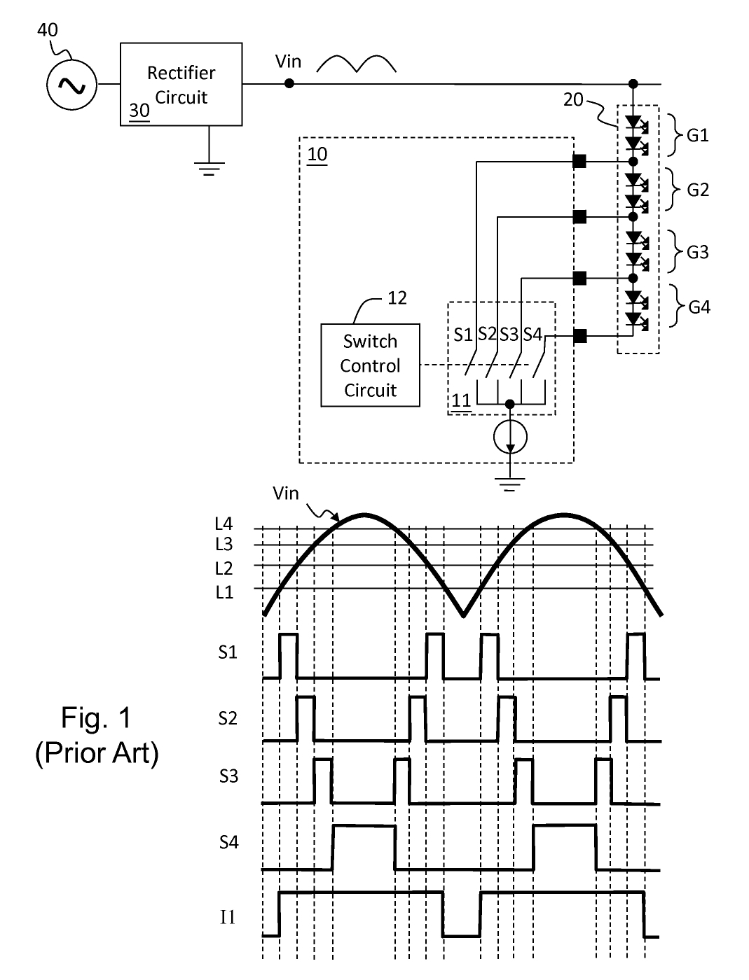

### DESCRIPTION OF THE PREFERRED EMBODIMENTS

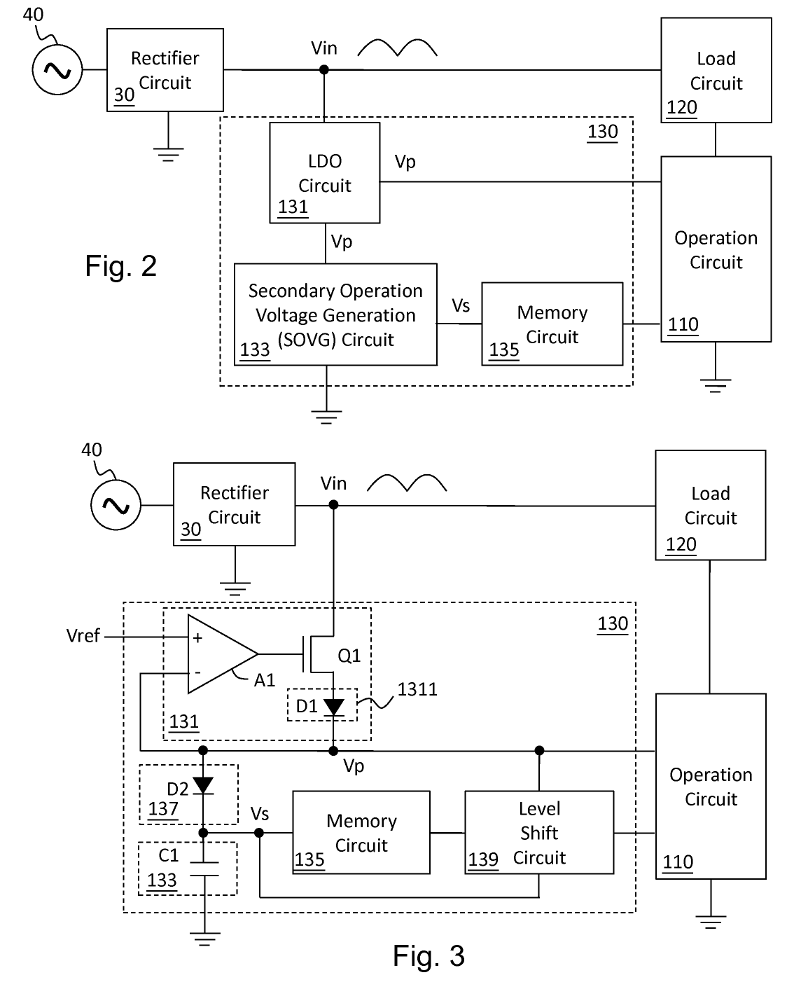

Please refer to FIG. 2 for a first embodiment according to the present invention. As shown in FIG. 2, a retaining circuit 130 includes a low dropout regulator (LDO) circuit 131, a secondary operation voltage generation (SOVG) circuit 133, and a memory circuit 135. The LDO circuit 131 receives the rectified input voltage Vin to generate a primary operation voltage Vp. The rectified input voltage Vin is generated by for example but not limited to the rectifier circuit 30, which rectifies an AC voltage generated by the AC power source 40 to generate the rectified input voltage Vin as shown by a small waveform in the figure. In another embodiment, the LDO circuit 131 may receive an AC voltage instead of the rectified input voltage Vin. The SOVG circuit 133 is coupled to the LDO circuit 131, for generating a secondary operation voltage Vs according to the primary operation voltage Vp, wherein the secondary operation voltage Vs is for example but not limited to lower than the primary operation voltage Vp. The memory circuit 135 is for storing at least one operation parameter (for example but not limited to the lightness setting, etc.); the memory circuit 135 is coupled to the SOVG circuit 133 to receive the secondary operation voltage Vs as its operation voltage. The primary operation voltage Vp is supplied to an operation circuit 110. The operation circuit 110 operates according to the operation parameter in a normal operation mode. When the primary operation voltage Vp is lower than a non-controlled level in a non-controlled mode (to be described in detail later), the operation circuit 110 retrieves the operation parameter from the memory circuit 135 to sustain its operation. In the context of the present invention, the term “non-controlled level” is used to indicate a minimum operation voltage level for the operation circuit 110 to operate normally; when the operation circuit 110 can not receive an operation voltage which is equal to or higher than the “non-controlled level”, the operation circuit 110 can not operate normally and is therefore “non-controlled”. Certainly, the operation circuit 110 is not limited to obtaining the operation parameter from the memory circuit 135 only in the non-controlled mode; it can use the operation parameter in the memory circuit 135 also in the normal operation mode. In this embodiment, the operation circuit 110 operates a load circuit 120 according to the operation parameter, wherein the load circuit 120 receives the rectified input voltage Vin and is for example but not limited to the LED circuit 20.

FIG. 3 shows a second embodiment of the present invention. This embodiment shows a more specific form of the retaining circuit 130 in the first embodiment. As shown in the figure, the retaining circuit 130 may further include a check device 137 and a level shift circuit 139 besides the LDO circuit 131, the SOVG circuit 133, and the memory circuit 135. The LDO circuit 131 may further include a check device 1311. The check device 1311 is for example but not limited to a diode D1 as shown in the figure, which prevents a current flowing from the operation circuit 110 or the SOVG circuit 133 to the LDO circuit 131. The check device 137 is coupled to the SOVG circuit 133, wherein the check device 137 is for example but not limited to a diode D2 as shown in the figure, which prevents a current flowing from the SOVG circuit 133 to the LDO circuit 131 and the operation circuit 110.

Still referring to FIG. 3, the LDO circuit 131 includes for example but not limited to an amplifier A1 and a transistor Q1. The LDO circuit 131 converts the rectified input voltage Vin to the primary operation voltage Vp according to a reference voltage Vref. The SOVG circuit 133 includes for example but not limited to a capacitor C1 as shown in the figure, for generating the secondary operation voltage Vs according to the primary operation voltage Vp. The memory circuit 135 can be embodied in various forms. Any circuit or device which can store an operation parameter may be used as the memory circuit 135, such as a capacitor, a dynamic random access memory (DRAM), a static random access memory (SRAM), a non-volatile memory, a latch circuit, etc. The memory circuit is as well known by those skilled in the art, so details thereof are omitted here. The level shift circuit 139 is coupled to the memory circuit 135 and the operation circuit 110, and it receives the primary operation voltage Vp and the secondary operation voltage Vs. The level shift circuit 139 transmits the operation parameter between the memory circuit 135 and the operation circuit 110. The level shift circuit 139 adjusts the level of the operation parameter so that the operation parameter is at a proper level as the operation parameter is transmitted to the memory circuit 135 and to the operation circuit 110 because operation voltages of the memory circuit 135 and the operation circuit 110 are different (the operation voltage of the memory circuit 135 is the secondary operation voltage Vs, while the operation voltage of the operation circuit 110 is primary operation voltage Vp).

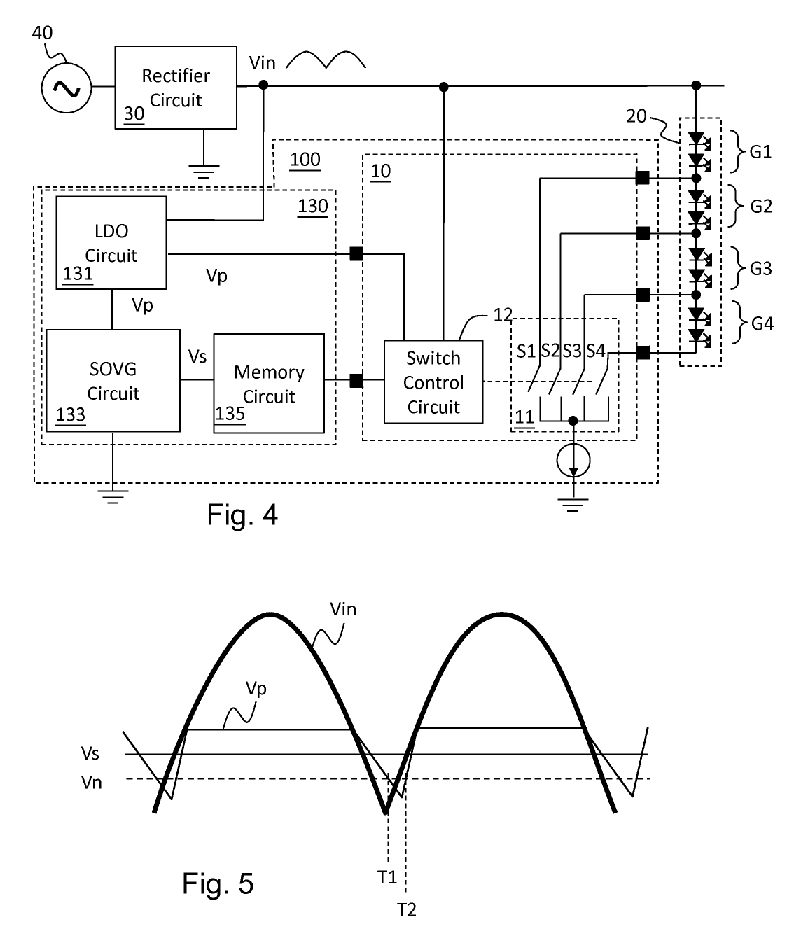

FIG. 4 shows a third embodiment of the present invention wherein the present invention is applied to alight emitting device driver circuit 100. As shown in FIG. 4, the light emitting device driver circuit 100 drives a light emitting device circuit. The light emitting device circuit is for example but not limited to the LED circuit 20, which includes for example but not limited to plural LEDs connected in series. The LED circuit 20 receives the rectified input voltage Vin. The light emitting device driver circuit 100 includes the switch module 10 and the retaining circuit 130. The switch module 10 includes plural switches S1-S4 and the switch control circuit 12. The plural switches are respectively coupled to at least one corresponding light emitting device. As shown in the figure, the switches S1-S4 are electrically connected to the LED groups G1, G2, G3, and G4. The switch control circuit 12 determines which one or ones of the light emitting devices are driven according to the rectified input voltage Vin. The retaining circuit 130 is coupled to the switch control circuit 10. The retaining circuit 130 includes the LDO circuit 131, the SOVG circuit 133, and the memory circuit 135. The LDO circuit 131 converts the rectified input voltage Vin to the primary operation voltage Vp. The SOVG circuit 133 is coupled to the LDO circuit 131, for generating the secondary operation voltage Vs according to the primary operation voltage Vp. The memory circuit 135 is coupled to the SOVG circuit 133, so that it can be powered by the secondary operation voltage Vs to store at least one operation parameter. The primary operation voltage Vp is supplied to the switch module 10. The switch module 10 operates according to the operation parameter in the normal operation mode. When the primary operation voltage Vp is lower than the non-controlled level in the non-controlled mode, the switch module 10 may not be able to operate normally. However, the secondary operation voltage Vs stays higher than the non-controlled level and is supplied to the memory circuit 135, so the operation parameter stored in the memory circuit 135 is not lost or changed. As the rectified input voltage Vin exceeds the non-controlled level again, the switch module 10 may retrieve the operation parameter from the memory circuit 135 to sustain the normal operation. In summary, when the primary operation voltage Vp is lower than the non-controlled level, the operation parameter is stored in the memory circuit 135 which is powered by the second operation voltage Vs that is kept higher than the non-controlled level, so the operation parameter is not changed or lost. Certainly, when the primary operation voltage Vp is higher than the non-controlled level in the normal operation, the operation parameter can also be stored in the memory circuit 135, and the secondary operation voltage Vs stays higher than the non-controlled level.

In the prior art, when the primary operation voltage Vp is lower than the non-controlled level, which is called the “non-controlled mode” in the context of the present invention, the prior art switch module 10 can not be ensured to perform a basic operation, and it may even lose the operation parameter. This non-controlled mode occurs when the rectified input voltage Vin and/or the primary operation voltage Vp is close to zero, due to that the internal circuitry of the switch module 10 is directly and only powered by the rectified input voltage Vin. In contrast, in the present invention, the retaining circuit 130 continues providing the secondary operation voltage Vs to maintain the required basic operation (such as the operation of the memory circuit 135 to hold the operation parameter) in the non-controlled mode. The memory circuit 135 is powered by the secondary operation voltage Vs so that it is able to keep storing the operation parameter, even when the rectified input voltage Vin and/or the primary operation voltage Vp is lower than the non-controlled level.

FIG. 5 shows signal waveforms of the rectified input voltage, the primary operation voltage Vp, the secondary operation voltage Vs, and the non-controlled level Vn. As shown in the figure, the rectified input voltage Vin is for example a rectified semi-sinusoidal signal, and the primary operation voltage Vp is generated by the LDO circuit by regulating the rectified input voltage Vin. The SOVG circuit 133 receives the primary operation voltage Vp to generate the secondary operation voltage Vs. When the rectified input voltage Vin decreases to become lower than a regulated level (i.e., the regulated target level of the LDO circuit), the primary operation voltage decreases correspondingly. When the primary operation voltage Vp is lower than the non-controlled level Vn (in a period between time points T1 and T2), the secondary operation voltage Vs is supplied to maintain the necessary basic operation (such as the operation of the memory circuit 135 to store one or more operation parameters) , while other non-basic operations can wait for the primary operation voltage Vp to recover to higher than the non-controlled level. In general, the secondary operation voltage Vs should be higher than the non-controlled level Vn.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, a device or circuit which does not substantially influence the primary function of a signal can be inserted between any two devices or circuits in the shown embodiments, such as a switch or the like, so the term. “couple” should include direct and indirect connections. For another example, the light emitting device that is applicable to the present invention is not limited to the LED as shown and described in the embodiments above, but may be any light emitting device with a forward terminal and a reverse terminal. For another example, the MOS device in the embodiments can be PMOS or NMOS device, with corresponding amendments to the circuit and the signals. For another example, each LED group does not necessarily have to contain a same number of LEDs (such as two LEDs), that is, the numbers of the LEDs may be different between different groups. In view of the foregoing, the spirit of the present invention should cover all such and other modifications and variations, which should be interpreted to fall within the scope of the following claims and their equivalents.

1. A retaining circuit, comprising:
a low dropout regulator (LDO) circuit, for converting rectified input voltage to a primary operation voltage;
a secondary operation voltage generation circuit, which is coupled. to the LDO circuit, for generating a secondary operation voltage according to the primary operation voltage; and
a memory circuit, which is coupled to the secondary operation voltage generation circuit, and powered by the secondary operation voltage to store at least one operation parameter;
wherein the primary operation. voltage is supplied to an operation circuit in a normal operation mode whereby the operation circuit operates according to the operation parameter, and when the primary operation voltage is lower than a non-controlled level whereby the operation circuit is in a non-controlled mode wherein the operation circuit can not perform a basic operation and loses the operation parameter, the memory circuit holds the operation parameter such that, after the operation circuit resumes the normal operation mode from he non-controlled mode, the operation circuit retrieves the operation parameter from the memory circuit to sustain operation.

2. The retaining circuit of claim 1, wherein the LDO circuit further comprises a first check device, for preventing a current flowing from the operation circuit or the secondary operation voltage generation circuit to the LOC) circuit.

3. The retaining circuit of claim 1, further comprising a second check device, which is coupled to the secondary voltage generation circuit, for preventing a current flowing from the secondary operation voltage generation. circuit to the LDO circuit and the operation circuit.

4. The retaining circuit of claim 1, further comprising a level shift circuit, which is coupled to the memory circuit and the operation circuit, for transmitting the operation parameter between the memory circuit and the operation circuit.

5. A light emitting device driver circuit for driving a light emitting device circuit, the light emitting device circuit including a. plurality of light emitting devices connected in series for receiving a rectified input voltage, the light emitting driver circuit comprising:
a switch module, which includes a plurality of switches and a switch control circuit, wherein the plural switches are respectively coupled to at least one of the light emitting devices correspondingly, and the switch control circuit determines which one or ones of the light emitting devices are driven according to the rectified input voltage; and
a retaining circuit, which is coupled to the switch control circuit, the retaining circuit including:
a low dropout regulator (LDO) circuit, for converting the rectified input voltage to a primary operation voltage;
a secondary operation voltage generation circuit, which is coupled to the LDO circuit, for generating a secondary operation. voltage according to the primary operation voltage; and
a memory circuit, which is coupled to the secondary operation voltage generation. circuit, and powered by the secondary operation voltage to store at least one operation parameter;
wherein the primary operation voltage is supplied to the switch module, in a normal operation mode whereby the switch module operates according to the operation parameter, and when the primary operation voltage is lower than a non-controlled level whereby the switch module is in a non-controlled mode wherein the switch module can not perform a basic operation and loses the operation parameter, the memory circuit holds the operation parameter such that, after the switch module resumes the normal operation mode from the non-controlled mode, the switch module retrieves the operation parameter from the memory circuit to sustain operation.

6. The driver circuit of claim 5, wherein the LDO circuit further includes a first check device, for preventing a current flowing from the switch module or the secondary operation voltage generation circuit to the LOG, circuit.

7. The driver circuit of claim 5, wherein the retaining circuit further includes a second check device, which is coupled to the secondary voltage generation circuit, for preventing a current flowing from the secondary operation voltage generation circuit to the LDO circuit and the switch module.

8. The driver circuit of claim 5, wherein the retaining circuit further includes a level shift circuit, which is coupled to the memory circuit and the switch module, for transmitting the operation parameter between the memory circuit and the switch module.
